(19) United States
(12) Patent Application Publication
(10) Pub. No.: US 2017/0200422 A1
(43) Pub. Date: Jul. 13, 2017

(54) IMAGE DISPLAY APPARATUS

(71) Applicant: Seiko Epson Corporation, Tokyo (JP)

(72) Inventors: Junichi OKAMOTO, Fujimi (JP); Masatoshi YONEKUBO, Hara (JP)

(21) Appl. No.: 15/402,459

(22) Filed: Jan. 10, 2017

(30) Foreign Application Priority Data
Jan. 13, 2016 (JP) 2016-004160

(51) Int. Cl. G09G 3/34; G02F 1/225; G02B 27/01; G09G 3/02; G09G 3/20

(52) U.S. Cl. CPC G09G 3/3413; G09G 3/02; G09G 3/2003; G02B 27/0172; G02F 1/225; G09G 2320/0242; G02B 2027/0116; G02F 2001/212

(57) ABSTRACT

An image display apparatus includes light sources that output red light, green light, and blue light, a light modulation part, in which the red light, green light, and blue light are entered, that can respectively independently modulate the red light, green light, and blue light, a lens that condenses the red light, green light, and blue light modulated by the light modulation part, and a light scanning part that performs scanning with the red light, green light, and blue light condensed by the lens, wherein a center axis of the green light passes closer to a center side of the lens than center axes of the red light and the blue light.

### BACKGROUND

1. Technical Field

The present invention relates to an image display apparatus.

2. Related Art

Image display apparatuses including retinal scanning head mount displays (HMDs) that scan retinas of users with laser beams and display images and head-up displays are known (for example, see Patent Document 1 (JP-A-2015-118359)).

For example, a projection apparatus described in Patent Document 1 as an example of the image display apparatuses has a laser source that outputs laser beams intensity-modulated according to image data and a scanner that performs two-dimensional scanning with the laser beams from the laser source via a projection lens.

Further, in the projection apparatus described in Patent Document 1, the laser source has laser diodes that output laser beams of the respective colors of red (R), green (G), blue (B), and the respective color laser beams from the laser source are entered into the projection lens via a plurality of optical fibers divided with respect to each color of RGB. Here, the opposite ends of the plurality of optical fibers to the laser source are bundled by a ferrule and bundles of the laser beams of RGB are projected to be on a line on the projection surface via the projection lens and the scanner.

In the projection apparatus described in Patent Document 1, the laser beams of RGB are directly intensity-modulated in the laser source and the so-called frequency shift that the wavelengths of the laser beams vary with changes of the environmental temperature or the like occurs, and, as a result, there is a problem of color tone shifts of images projected on the projection surface.

### SUMMARY

An advantage of some aspects of the invention is to provide an image display apparatus that may display images with reduced color shifts.

The advantage can be achieved by the following configurations.

An image display apparatus according to an aspect of the invention includes a light source part including a first light source that outputs a green first light and a second light source that outputs a second light in a different color from the color of the first light, a light modulation part, in which the first light and the second light are entered, that can respectively independently modulate the first light and the second light, a condenser lens that condenses the first light and the second light modulated by the light modulation part, and a light scanning part that performs scanning with the first light and the second light condensed by the condenser lens, wherein a center axis of the first light passes closer to a center side of the condenser lens than a center axis of the second light.

According to the image display apparatus, it is not necessary to directly modulate the first light source and the second light source, but the lights from the first light source and the second light source may be modulated by the light modulation part outside of the first light source and the second light source. Accordingly, the frequency shifts of the first light and the second light due to direct modulation of the first light source and the second light source may be reduced and, as a result, color tone shifts of displayed images may be reduced and high-quality displayed images may be obtained. Further, the center axis of the first light passes closer to the center side of the condenser lens than the center axis of the second light, and thereby, the quality of pixels of the green first light having the higher relative visibility may be preferentially made higher than the quality of pixels of the second light having the lower relative visibility. As a result, also, in this regard, the high-quality displayed images may be realized.

In the image display apparatus according to the aspect of the invention, it is preferable that the light modulation part includes a substrate formed using a material having an electrooptical effect, a first light waveguide provided on the substrate, into which the first light is entered, a second light waveguide provided on the substrate, into which the second light is entered, a first modulation part that modulates the first light entering the first light waveguide, and a second modulation part that modulates the second light entering the second light waveguide.

With this configuration, the first light and the second light may be respectively independently modulated using changes of refractive indexes due to the electrooptical effect of the substrate.

In the image display apparatus according to the aspect of the invention, it is preferable that respective modulation methods of the first modulation part and the second modulation part are Mach-Zehnder methods.

With this configuration, the structures of the light modulation parts may be made relatively simple and the modulation widths of the light modulation parts may be arbitrarily and easily adjusted.

In the image display apparatus according to the aspect of the invention, it is preferable that the first light is a luminous flux containing a plurality of light beams of green, and the second light is a luminous flux containing a plurality of light beams of a different color from that of the first color.

With this configuration, higher resolution of the displayed images may be realized.

In the image display apparatus according to the aspect of the invention, it is preferable that the light modulation part branches and outputs the first light into a plurality of first lights and branches and outputs the second light into a plurality of second lights.

With this configuration, the respective first light and second light may be formed by pluralities of bundles of lights without increase in the number of light sources while the apparatus is downsized.

In the image display apparatus according to the aspect of the invention, it is preferable that the light source part includes a third light source that outputs a third light in a different color from the colors of the first light and the second light, and the light modulation part, into which the third light is entered, that can modulate the third light independently of the first light and the second light.

With this configuration, the color reproduction range of the displayed images may be expanded.

In the image display apparatus according to the aspect of the invention, it is preferable that the center axis of the first light passes closer to the center side of the condenser lens than a center axis of the third light.

With this configuration, the quality of the pixels of the green first light having the higher relative visibility may be preferentially made higher than the quality of pixels of the third light having the lower relative visibility. As a result, high-quality full-color displayed images may be realized.

It is preferable that the image display apparatus according to the aspect of the invention is a head mount display.

With this configuration, the head mount display that can display high-quality images may be realized.

It is preferable that the image display apparatus according to the aspect of the invention is a head-up display.

With this configuration, the head-up display that can display high-quality images may be realized.

### BRIEF DESCRIPTION OF THE DRAWINGS

The invention will be described with reference to the accompanying drawings, wherein like numbers reference like elements.

FIG. 1 shows a schematic configuration of an image display apparatus (head mount display) according to a first embodiment of the invention.

FIG. 2 is a perspective view of the head mount display shown in FIG. 1.

FIG. 3 is a schematic configuration diagram of an image display unit of the head mount display shown in FIG. 1.

FIG. 4 is a schematic configuration diagram of a picture light generation part shown in FIG. 3.

FIG. 5 is a plan view of an optical scanner shown in FIG. 4.

FIG. 6 schematically shows scanning trajectories of signal lights on a projection surface in the image display apparatus shown in FIG. 1.

FIG. 7 is a perspective view of a light modulation part shown in FIG. 4.

FIG. 8 is a plan view of the light modulation part shown in FIG. 4.

FIG. 9 shows positional relationships between a condenser lens and the signal lights (as seen from a direction perpendicular to an optical axis) shown in FIG. 4.

FIG. 10 shows the positional relationships between the condenser lens and the signal lights (as seen from a direction parallel to the optical axis) shown in FIG. 4.

FIG. 11 shows positional relationships between the projection surface and imaging points of the signal lights.

FIG. 12 is a plan view of a light modulation part of an image display apparatus according to a second embodiment of the invention.

FIG. 13 shows positional relationships between a condenser lens and signal lights (as seen from a direction parallel to an optical axis) shown in FIG. 12.

FIG. 14 schematically shows scanning trajectories of the signal lights on a projection surface in the image display apparatus shown in FIG. 12.

FIG. 15 shows positional relationships between a condenser lens and signal lights (as seen from a direction parallel to an optical axis) in an image display apparatus according to a third embodiment of the invention.

FIG. 16 shows positional relationships between a condenser lens and signal lights (as seen from a direction parallel to an optical axis) in an image display apparatus according to a fourth embodiment of the invention.

FIG. 17 shows positional relationships between a condenser lens and signal lights (as seen from a direction parallel to an optical axis) in an image display apparatus according to a fifth embodiment of the invention.

FIG. 18 shows positional relationships between a condenser lens and signal lights (as seen from a direction parallel to an optical axis) in an image display apparatus according to a sixth embodiment of the invention.

FIG. 19 shows a schematic configuration of an image display apparatus (head-up display) according to a seventh embodiment of the invention.

### DESCRIPTION OF EXEMPLARY EMBODIMENTS

As below, preferred embodiments of an image display apparatus according to the invention will be explained with reference to the accompanying drawings.

### First Embodiment

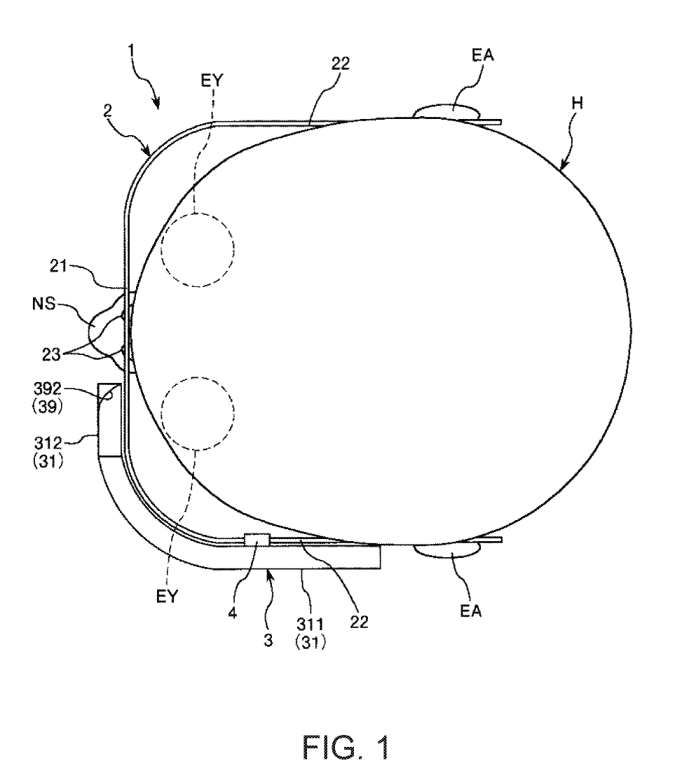

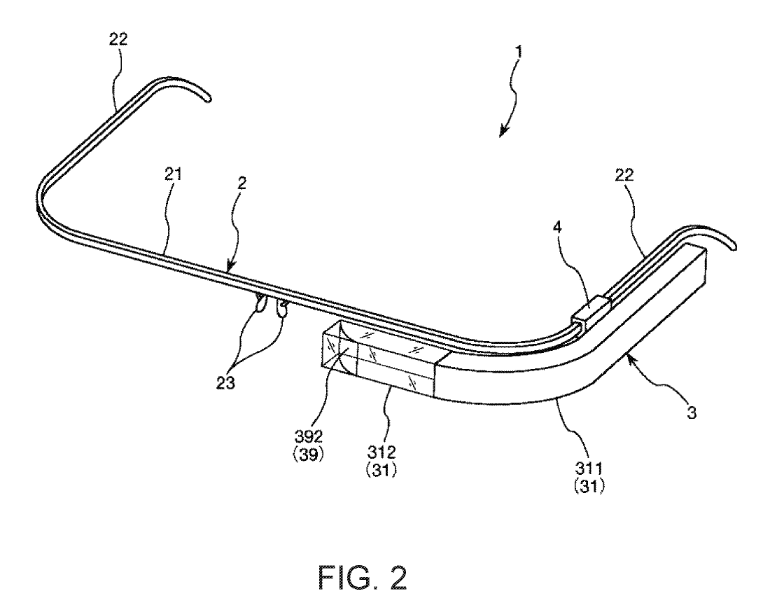

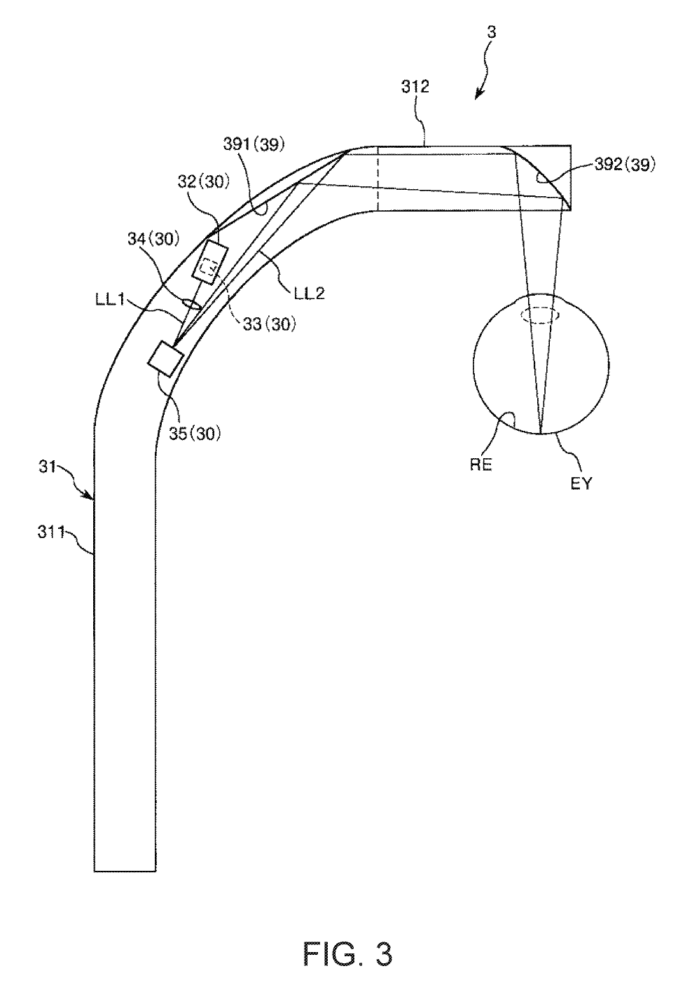

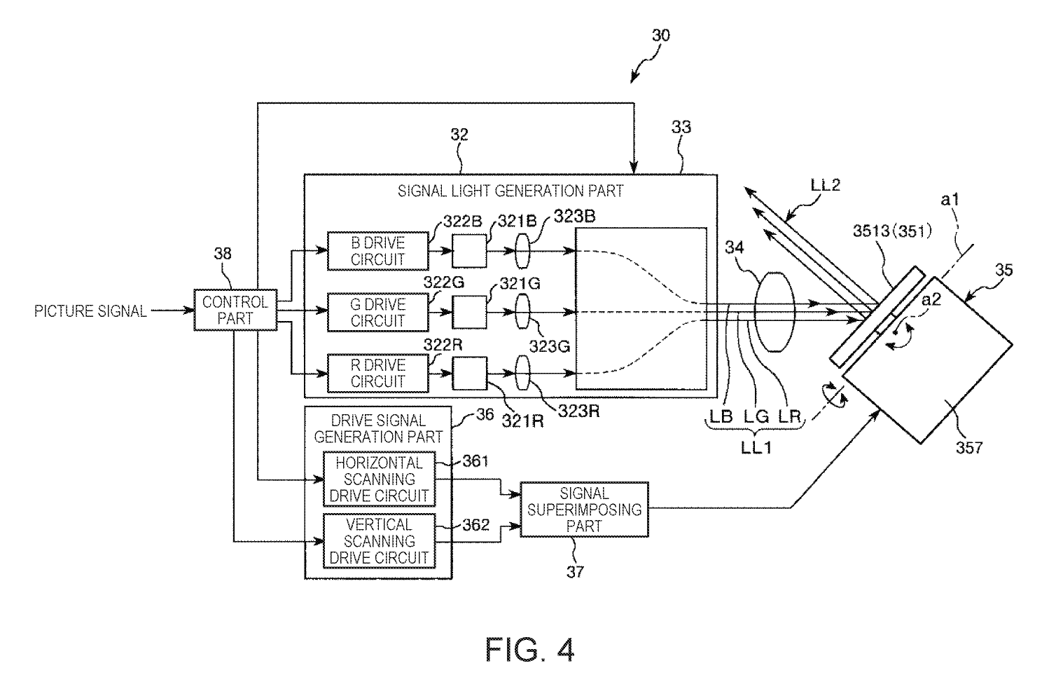

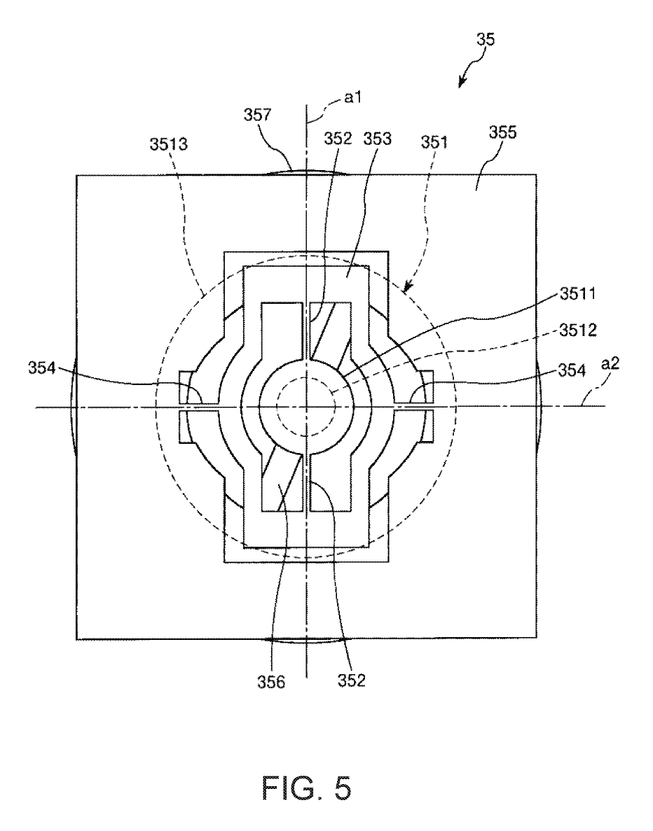

FIG. 1 shows a schematic configuration of an image display apparatus (head mount display) according to the first embodiment of the invention. FIG. 2 is a perspective view of the head mount display shown in FIG. 1. FIG. 3 is a schematic configuration diagram of an image display unit of the head mount display shown in FIG. 1. FIG. 4 is a schematic configuration diagram of a picture light generation part shown in FIG. 3. FIG. 5 is a plan view of an optical scanner shown in FIG. 4.

As shown in FIG. 1, an image display apparatus 1 of the embodiment is a head mounted image display apparatus (head mount display) having an appearance like spectacles, is attached to a head H of a user for use, and allows the user to visually recognize an image as a virtual image superimposed on an outside world image.

As shown in FIG. 1, the image display apparatus 1 has a frame 2 attached to the head H of the user, an image display unit 3 that displays images to be visually recognized by the user with the frame 2 attached thereto, and a fixing part 4 that fixes the image display unit 3 to the frame 2.

Here, the image display apparatus 1 is the so-called monocular head mount display and the image display unit 3 irradiates one (left in FIG. 1) eye EY of the user with picture light and displays an image. Note that the image display unit 3 may be fixed to the frame 2 via the fixing part 4 to perform image display for the right eye EY of the user. Or, the image display unit 3 and the fixing part 4 may be adapted to switch between a state of image display for the left eye EY of the user and a state of image display for the right eye EY of the user. Or, two sets of the image display unit 3 and the fixing part 4 may be provided for one frame 2 for concurrent image display for both eyes EY of the user.

As below, the respective parts of the image display apparatus 1 will be sequentially and briefly explained.

### Frame

The frame 2 has a function of supporting the image display unit 3 via the fixing part 4. As shown in FIGS. 1 and 2, the frame 2 has a shape like a spectacle frame. The frame 2 has a front part 21 having a longitudinal shape, a pair of temple parts 22 connected to both ends of the front part 21 in the longitudinal direction, and a nose pad part 23 provided in the center portion of the front part 21 in the longitudinal direction.

As shown in FIG. 1, the frame 2 is attached to the head H of the user with the pair of temple parts 22 in contact with ears EA on both sides of the user and the nose pad part 23 in contact with a nose NS of the user in use.

Further, a constituent material of the frame 2 is not particularly limited. The same material as the constituent material of a known spectacle frame including e.g. a resin material, a metal material, and fiber-reinforced plastic may be used.

The shape of the frame 2 is not limited to that illustrated as long as the frame may be attached to the head H of the user. Further, as the frame 2, ready-made spectacles, sunglasses, or the like may be used.

To the frame 2, the image display unit 3 is fixed via the fixing part 4.

### Fixing Part

As shown in FIGS. 1 and 2, the fixing part 4 has a function of fixing the image display unit 3 to the frame 2. Note that the shape of the fixing part 4 is not limited to that illustrated as long as the part may fix the image display unit 3 to the frame 2. Or, the fixing part 4 may be fixed to at least one of the frame 2 and the image display unit 3 using an adhesive or the like or detachably attached using a method using a magnetic force, a method using a clip, or the like. Or, the fixing part 4 may be integrally formed with at least one of the frame 2 and the image display unit 3.

### Image Display Unit

The image display unit 3 has a function of irradiating the eye EY of the user with picture light and displaying an image. As shown in FIG. 3, the image display unit 3 has an exterior part 31 having a casing 311 and a light transmissive part 312, and a picture light generation part 30 and an optical system 39 provided within the exterior part 31. As below, the respective parts of the image display unit 3 will be sequentially and briefly explained.

### Exterior Part

The exterior part 31 has the casing 311 and the light transmissive part 312 supported by the casing 311.

The casing 311 has a shape extending over a part between the front part 21 and one temple part 22 of the above described frame 2 along the parts (elongated shape) in the state in which the image display unit 3 is fixed to the frame 2 via the fixing part 4. Further, one end of the casing 311 opens and the light transmissive part 312 is provided to close the opening. A constituent material of the casing 311 includes, but not particularly limited to, e.g. a resin material, a metal material, or the like. Note that the outer shape of the casing 311 is an example and includes, but not particularly limited to, e.g. a block shape, a flat shape, or the like.

The light transmissive part 312 is formed principally using a colorless and transparent material (resin material, glass material, or the like), and a reflection part 392 of the optical system 39, which will be described later, is provided therein.

### Picture Light Generation Part

The picture light generation part 30 is provided within the casing 311 of the above described exterior part 31. As shown in FIG. 4, the picture light generation part 30 has a signal light generation part 32 that generates a signal light LL1 (modulated light) intensity-modulated according to a picture signal (image information), a lens 34 that the signal light LL1 from the signal light generation part 32 enters, a light scanning part 35 that performs scanning of the signal light LL1 passing through the lens 34, a drive signal generation part 36 that generates a horizontal scanning drive signal and a vertical scanning drive signal used for driving of the light scanning part 35, a signal superimposing part 37 that superimposes the two signals from the drive signal generation part 36, and a control part 38 that controls the signal light generation part 32 and the drive signal generation part 36.

### Signal Light Generation Part

The signal light generation part 32 has a plurality of light sources 321R, 321G, 321B (light source parts) that output lights at different wavelengths from one another, a plurality of drive circuits 322R, 322G, 322B, a plurality of lenses 323R, 323G, 323B, and a light modulation part 33.

The light source 321R (second light source) has a function of outputting red light (second light), the light source 321G (first light source) has a function of outputting green light (first light), and the light source 321B (third light source) has a function of outputting blue light (third light). These lights of three colors are used, and thereby, the color reproduction range of the displayed images may be expanded and full-color images may be displayed. The light sources 321R, 321G, 321B are respectively not particularly limited. For example, laser diodes, LEDs, or the like may be used. The light sources 321R, 321G, 321B are electrically connected to the drive circuits 322R, 322G, 322B, respectively.

The drive circuit 322R has a function of driving the above described light source 321R, the drive circuit 322G has a function of driving the above described light source 321G, and the drive circuit 322B has a function of driving the above described light source 321B. The three (three color) lights output from the light sources 321R, 321G, 321B driven by the drive circuits 322R, 322G, 322B enter the light modulation part 33 via the lenses 323R, 323G, 323B.

The respective lenses 323R, 323G, 323B are condenser lenses. The lenses 323R, 323G, 323B have functions (coupling functions) of adjusting the diameters of the lights output from the light sources 321R, 321G, 321B and enter the lights into the light modulation part 33, respectively. Note that the lenses 323R, 323G, 323B may parallelize the lights output from the light sources 321R, 321G, 321B.

The light modulation part 33 has a function of respectively and independently intensity-modulating the lights output from the light sources 321R, 321G, 321B. Thereby, the signal light LL1 including red light LR, green light LG, and blue light LB intensity-modulated according to the picture signal may be generated. Note that the light modulation part 33 will be described later in detail.

The signal light LL1 generated by the signal light generation part 32 enters the lens 34.

### Lens

The lens 34 has a function of adjusting the radiation angle of the signal light LL1. That is, the lens 34 is a condenser lens that condenses the signal light LL1 modulated by the light modulation part 33. The lens 34 is e.g. a collimator lens. Here, the signal light LL1 is a bundle of lights in which center axes of the red light LR, the green light LG, and the blue light LB are not aligned with one another. When the signal light LL1 passes through the lens 34, the center axis of the red light LR passes closer to the center of the lens 34 than the center axes of the green light LG and the blue light LB. Thereby, image quality deterioration due to aberration of the lens 34 may be reduced. Note that this will be described later in detail with the explanation of the light modulation part 33.

The signal light LL1 passing through the lens 34 enters the light scanning part 35.

### Light Scanning Part

The light scanning part 35 is an optical scanner and has a function of generating a picture light LL2 (scanning light) by two-dimensional scanning of the signal light LL1 from the signal light generation part 32. As shown in FIG. 5, the light scanning part 35 includes a movable mirror portion 351, two axis portions 352, a frame body portion 353, two axis portions 354, a supporting portion 355, a magnet 356, and a coil 357.

Here, the movable mirror portion 351 and the two axis portions 352 form “first vibration system” that torsionally vibrates about an axis line a1 with the movable mirror portion 351 as “first mass” and the two axis portions 352 as “first springs”. Further, the movable mirror portion 351, the two axis portions 352, the frame body portion 353, the two axis portions 354, and the magnet 356 form “second vibration system” that torsionally vibrates about an axis line a2 orthogonal to the axis line a1 with the movable mirror portion 351, the two axis portions 352, the frame body portion 353, and the magnet 356 as “second mass” and the two axis portions 354 as “second spring”.

The movable mirror portion 351 has a base portion 3511 and a light reflection plate 3513 fixed to the base portion 3511 via a spacer 3512. The base portion 3511, the spacer 3512, and the light reflection plate 3513 are formed using e.g. a silicon material. Further, the base portion 3511 is integrally formed with the axis portions 352, the frame body portion 353, the axis portions 354, and the supporting portion 355. Furthermore, the respective parts between the base portion 3511, the spacer 3512, and the light reflection plate 3513 are joined by a method using a joining material such as an adhesive agent or a brazing material, a solid joining method, or the like. Note that the spacer 3512 and the light reflection plate 3513 may be formed using a glass material or integrally formed.

A light reflection portion having light reflectivity (not shown) is provided on the surface of the light reflection plate 3513 opposite to the base portion 3511. Further, the base portion 3511 of the movable mirror portion 351 is surrounded by the frame-like frame body portion 353 in a plan view as seen from the thickness direction of the base portion 3511.

The base portion 3511 is supported swingably about the axis line a1 by the frame body portion 353 via the two axis portions 352. Further, the frame body portion 353 is supported swingably about the axis line a2 orthogonal to the axis line a1 by the supporting portion 355 via the two axis portions 354. Furthermore, angle detection sensors (not shown) such as e.g. piezoelectric resistive elements are provided in at least either axis portions of the axis portions 352 or the axis portions 354. The angle detection sensors output signals according to the swing angles about the axis lines a1, a2 of the movable mirror portion 351. The output is input to the control part 38 via a cable (not shown).

To the surface of the above described frame body portion 353 opposite to the light reflection plate 3513, the magnet 356 is joined using an adhesive agent or the like. The magnet 356 has a longitudinal shape extending along a direction tilted with respect to the axis line a1 and the axis line a2. As the magnet 356, e.g. neodymium magnet, ferrite magnet, samarium-cobalt magnet, alnico magnet, bonded magnet, or the like may be preferably used.

The coil 357 is provided beneath the magnet 356. The drive signal generation part 36 is electrically connected to the coil 357 via the signal superimposing part 37. Thereby, the horizontal scanning drive signal and the vertical scanning drive signal generated by the drive signal generation part 36 are superimposed by the signal superimposing part 37 and input to the coil 357.

### Drive Signal Generation Part

The drive signal generation part 36 has a drive circuit 361 that generates a horizontal scanning drive signal used for horizontal scanning of the light scanning part 35 and a drive circuit 362 that generates a vertical scanning drive signal used for vertical scanning of the light scanning part 35. Here, the horizontal scanning drive signal and the vertical scanning drive signal are respectively signals at voltages changing in periods different from each other. More specifically, for example, the frequency of the horizontal scanning drive signal is set to be equal to the torsional resonance frequency of the first vibration system of the above described light scanning part 35, and the frequency of the vertical scanning drive signal is set to a value different from the torsional resonance frequency of the second vibration system and smaller than the frequency of the horizontal scanning drive signal (for example, the frequency of the horizontal scanning drive signal is set to about 18 kHz and the frequency of the vertical scanning drive signal is set to be about 60 Hz).

### Signal Superimposing Part

The signal superimposing part 37 has an adder (not shown) that superimposes the above described horizontal scanning drive signal and vertical scanning drive signal, and applies the superimposed voltage to the coil 357 of the light scanning part 35. When the drive signal formed by superimposition of the horizontal scanning drive signal and vertical scanning drive signal is input to the coil 357, the movable mirror portion 351 swings about the axis line a1 at the frequency of the horizontal scanning drive signal and swings about the axis line a2 at the frequency of the vertical scanning drive signal.

### Control Part

The control part 38 has a function of controlling driving of the drive circuits 322R, 322G, 322B of the signal light generation part 32, the drive circuits 361, 362 of the drive signal generation part 36, and the light modulation part 33 based on the picture signals (image signals). Thereby, the signal light generation part 32 generates the signal light LL1 modulated according to the image information and the drive signal generation part 36 generates the horizontal scanning drive signal and the vertical scanning drive signal according to the image information. Particularly, the control part 38 has a function of controlling the driving of the light modulation part 33 based on the picture signals (image signals). Thereby, the intensity modulation of light may be performed by the light modulation part 33, not by the light sources 321R, 321G, 321B. Further, the control part 38 has a function of controlling the drive signal generation part 36 based on the detection results of the angle detection sensors (not shown) provided in the light scanning part 35.

The picture light LL2 (a bundle of signal lights LL1 at predetermined time intervals) generated by the picture light generation part 30 having the above described configuration enters the optical system 39 as shown in FIG. 3.

### Optical System

The optical system 39 has a function of guiding the picture light LL2 from the picture light generation part 30 to the eye EY of the user in use. The optical system 39 has a mirror 391 provided within the casing 311 of the above described exterior part 31 and the reflection part 392 provided in the light transmissive part 312 of the exterior part 31.

The mirror 391 has a function of reflecting the picture light LL2 from the picture light generation part 30 toward the reflection part 392. The mirror 391 may include e.g. a metal thin film or dielectric multilayer film or a hologram element. When the hologram element is used, the degree of freedom of placement of the mirror 391 may be made higher.

The reflection part 392 has a function of reflecting the picture light LL2 from the light scanning part 35 toward the eye EY of the user and a function of transmitting transmitting outside world light toward the eye EY of the user. Thereby, the user may visually recognize the image (virtual image) formed by the picture light LL2 while visually recognizing an outside world image. In other words, a see-through head mount display may be realized. The reflection part 392 has a light-transmissive reflection film including a hologram element, a metal thin film, or a dielectric multilayer film, for example.

Note that the above described configuration of the optical system 39 is an example and determined depending on the placement of the picture light generation part 30, the shape of the casing 311, etc., not limited to that. For example, the optical system may have another optical element such as a lens and the number of mirrors is arbitrary. Or, the optical system. 39 may have an optical waveguide or optical fiber. Or, the mirror 391 may be omitted depending on the placement, the configuration, etc. of the picture light generation part 30.

As above, the configuration of the image display apparatus 1 is briefly explained. In the image display apparatus 1 explained as above, as described above, the picture light LL2 is generated by scanning with the signal light LL1 output from the signal light generation part 32 by the light scanning part 35 having the movable mirror portion 351 swinging about the axis lines a1, a2 orthogonal to each other. In this regard, the signal light generation part 32 outputs the signal light LL1 when the movable mirror portion 351 swings toward one side about the axis line a1, but does not output light when the portion swings toward the other side. Accordingly, in the light scanning part 35, scanning is performed with the signal light LL1 when the movable mirror portion 351 swings toward one side about the axis line a1, but scanning is not performed with the signal light LL1 when the portion swings toward the other side. The red light LR, green light LG, and blue light LB of the signal light LL1 forming the picture light LL2 generated in the above described manner respectively image on an imaging surface (projection surface). Here, “imaging surface” refers to a surface on which an image is formed by the image display apparatus 1, in other words, a surface on which the signal light LL1 used for scanning by the light scanning part 35 focus (forms) an image. In the embodiment, “imaging surface” is formed on a retina RE of the eye EY of the user.

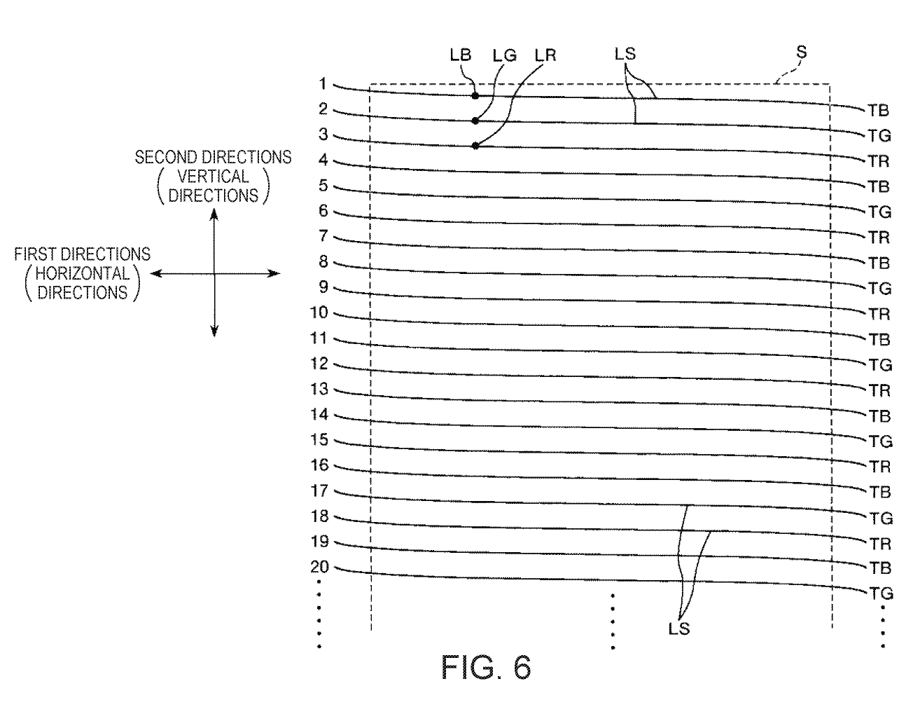

FIG. 6 schematically shows scanning trajectories of signal lights on the projection surface in the image display apparatus shown in FIG. 1.

As shown in FIG. 6, the red light LR, green light LG, blue light LB of the signal light LL1 used for scanning in the light scanning part 35 form scanning trajectories TR, TG, TB on the imaging surface by scanning only either of an outward path or return path in the first directions (horizontal directions), respectively. Note that, hereinafter, lines arranged at equal intervals in the second directions (vertical directions) orthogonal to the first directions on the imaging surface are referred to as “scanning lines LS”, and the respective scanning trajectories TR, TG, TB are formed on the scanning lines LS. Further, the plurality of scanning lines LS are sequentially referred to from the top as “LS1 (first scanning line)”, “LS2 (second scanning line)”, “LS3 (third scanning line)” . . . . Note that, in the embodiment, in an image display area S as an area in which the user visually recognizes an image, the scanning lines LS correspond to horizontal scanning lines for image display. Furthermore, in FIG. 6, of LS1, LS2, LS3 . . . , only the numbers are shown on the left ends of the scanning lines LS and the signs of the scanning trajectories formed by the scanning lines LS with the numbers are shown on right ends of the scanning lines LS.

As shown in FIG. 6, the scanning trajectories TB of the blue light LB are located on the scanning lines LS1, LS4, LS7 . . . , the scanning trajectories TG of the green light LG are located on the scanning lines LS2, LS5, LS8 . . . , and the scanning trajectories TR of the red light LR are located on the even-numbered scanning lines LS3, LS6, LS9 . . . . That is, scanning with the red light LR, green light LG, and blue light LB is respectively performed for three scanning lines LS at a time, and the scanning trajectories TR, TG, TB are repeatedly placed sequentially from the scanning line LS1 without overlapping with one another. Further, an irradiated point of the red light LR, an irradiated point of the green light LG, and an irradiated point of the blue light LB at a certain time are arranged side by side in the second directions as shown by three points in FIG. 6, and used for scanning in the first directions and the second directions with the positional relationship maintained. Note that the irradiated point of the red light LR, the irradiated point of the green light LG, and the irradiated point of the blue light LB are not necessarily arranged side by side in the second directions, but may be placed so that the respective scanning trajectories TR, TG, TB may be arranged in the second directions. For example, the respective irradiated points may be arranged in directions crossing the first directions. Further, the scanning lines LS do not overlap with one another and are arranged at equal intervals in the second directions in any part (center part or both end parts) in the first directions. Accordingly, images with uniform pixel density and less uneven brightness may be displayed.

The scanning trajectories TR, the scanning trajectories TG, and the scanning trajectories TB are arranged in the image display area S as described above, and thereby, the user may visually recognize the two-dimensional image by the afterimage phenomenon of the eye EY. Then, the red light LR, green light LG, and blue light LB blink on and off independently from one another, and the visually-recognized two-dimensional image is an image having colors and brightness according to image information (e.g., a full-color image).

In both end port ions of the respective scanning lines LS, the scanning speed is lower and distortion in the vertical directions (second directions) is larger than those in the center portion, and it is preferable not to use the end portions as the image display area S. The image display area S is set as shown in FIG. 6, and thereby, more homogeneous images with higher accuracy may be displayed. Further, in the embodiment, the scanning lines LS extend at tilts with respect to the horizontal directions (first directions), and, for example, the light scanning part 35 may be provided at a slight tilt so that the scanning lines LS and the frame edge of the image display area S may be as parallel as possible. Thereby, the image quality of the displayed images may be made higher.

In the above explained image display apparatus 1, as described above, the light modulation part 33 of the signal light generation part 32 respectively and independently intensity-modulate the lights output from the light sources 321R, 321G, 321B. Then, the lights output from the light modulation part 33 enter the light scanning part 35 via the lens 34. As below, the light modulation part 33 will be described in detail.

### Detailed Explanation of Light Modulation Part

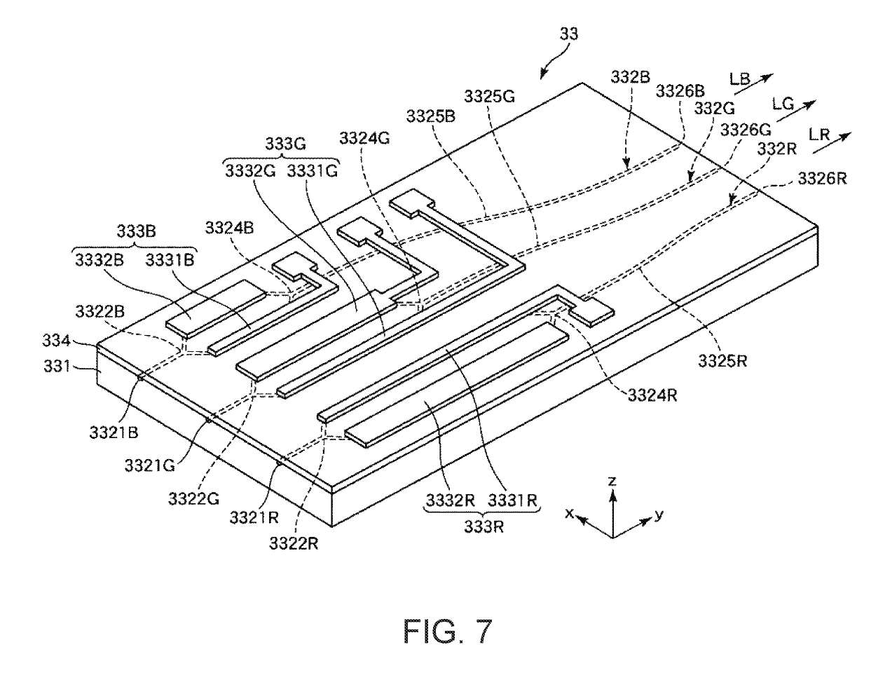

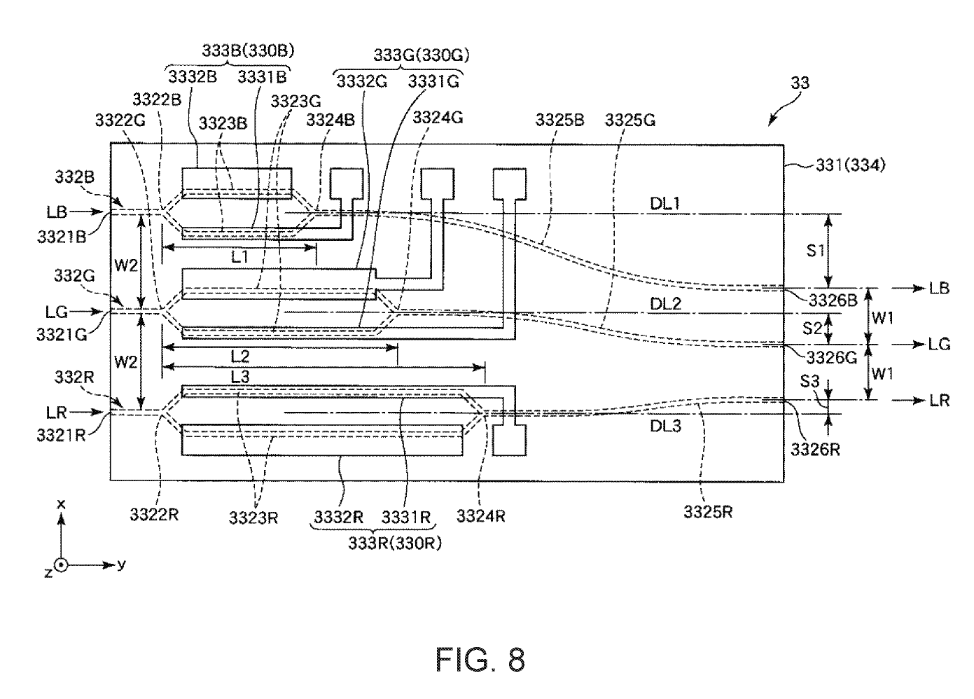

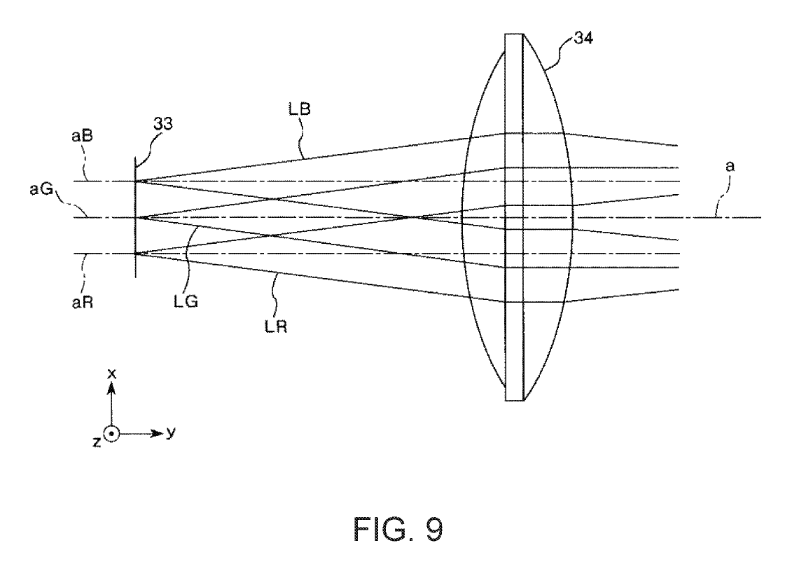

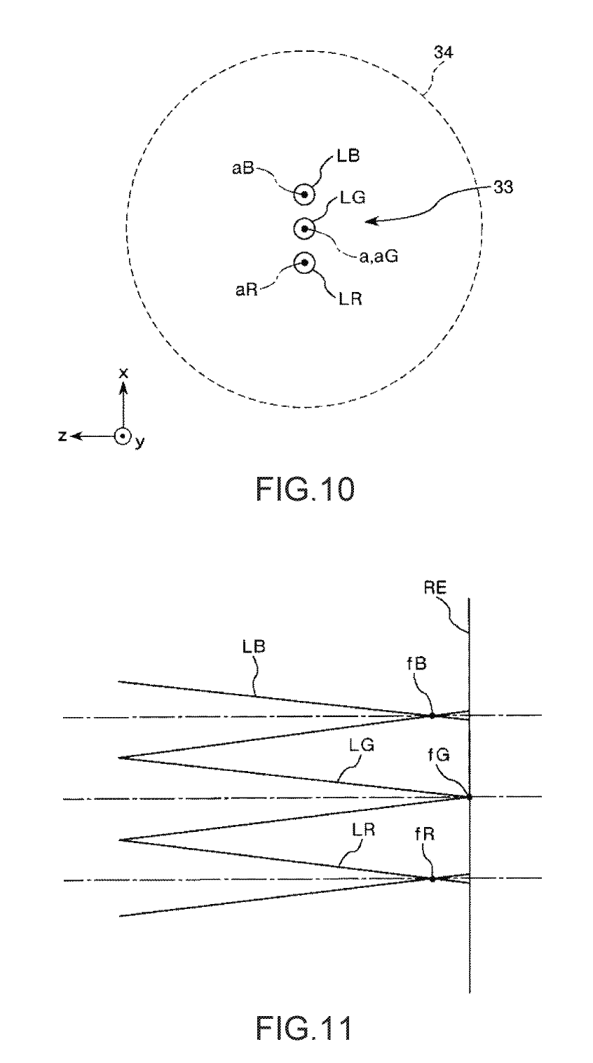

FIG. 7 is a perspective view of the light modulation part shown in FIG. 4. FIG. 8 is a plan view of the light modulation part shown in FIG. 4. FIG. 9 shows positional relationships between a condenser lens and the signal lights (as seen from a direction perpendicular to an optical axis) shown in FIG. 4. FIG. 10 shows the positional relationships between the condenser lens and the signal lights (as seen from a direction parallel to the optical axis) shown in FIG. 4. FIG. 11 shows positional relationships between the projection surface and imaging points of the signal lights.

Note that, in FIGS. 7 to 10, for convenience of explanation, as three axes orthogonal to one another, an x-axis, a y-axis, and a z-axis are shown and the tip end sides of the illustrated arrows are “+” and the base end sides are “−”. Further, the directions in parallel to the x-axis are referred to as “x-axis directions”, the directions in parallel to the y-axis are referred to as “y-axis directions”, and the directions in parallel to the z-axis are referred to as “z-axis directions”.

The light modulation part 33 is the so-called Mach-Zehnder light modulator and respectively and independently intensity-modulate the lights output from the light sources 321R, 321G, 321B. The light modulation part 33 includes a substrate 331, a light waveguide 332R (second light waveguide), a light waveguide 332G (first light waveguide), a light waveguide 332B (third light waveguide) formed on the substrate 331, an electrode 333R (second electrode), an electrode 333G (first electrode), an electrode 333B (third electrode) provided on the substrate 331, and a buffer layer 334 inserted between the substrate 331 and the electrodes 333R, 333G, 333B.

The substrate 331 has a flat plate shape in a rectangular shape in the plan view and is formed using a material having an electrooptical effect. The electrooptical effect is a phenomenon that a refractive index of a material changes when an electric field is applied to the material including the Pockels effect that the refractive index is proportional to the electric field and the Kerr effect that the refractive index is proportional to the square of the electric field. In the respective drawings, the direction parallel to the short side of the substrate 331 is referred to as “x-axis direction”, the direction parallel to the long side of the substrate 331 is referred to as “y-axis direction”, and the thickness direction of the substrate 331 is referred to as “z-axis direction”.

The material having the electrooptical effect includes e.g. an inorganic material such as lithium niobate (LiNbO₃), lithium tantalate (LiTaO₃), lead lanthanum zirconate titanate (PLZT), or potassium phosphate titanate (KTiOPO₄), polythiophene, a liquid crystal material, and an organic material such as a material of an electrooptically active polymer doped with charge transport molecules, a material of a charge transport polymer doped with electrooptical dye, a material of an inactive polymer doped with charge transport molecules and electrooptical dye, a material containing a charge transport part and an electrooptical part in a main chain or side chain of a polymer, or a material doped with tricyanofurane (TCF) as an acceptor, etc.

Of them, as the constituent material of the substrate 331, particularly, lithium niobate is preferably used. The lithium niobate has a relatively large electrooptical coefficient, and thereby, when the light intensity is modulated in the light modulation part 33, the drive voltage may be made lower and the light modulation part 33 may be downsized.

Further, it is preferable that the material of the substrate 331 is single crystal or solid solution crystal. Thereby, the light transmissivity of the substrate 331 is better and light transmission efficiency of the light waveguides 332R, 332G, 332B formed in the substrate 331 may be improved.

The light waveguides 332R, 332G, 332B are provided to be optically independent of one another. The red light LR enters the light waveguide 332R, the green light LG enters the light waveguide 332G, and the blue light LB enters the light waveguide 332B. In the embodiment, the light waveguide 332R, the light waveguide 332G, and the light waveguide 332B are arranged in this order from the −x-axis direction side toward the +x-axis direction side.

Further, the light waveguides 332R, 332G, 332B are light waveguides formed by partial modification of the substrate 331. The method of forming the light waveguides 332R, 332G, 332B in the substrate 331 includes e.g. a proton exchange method, Ti diffusion method, etc. Of them, the proton exchange method is a method of immersing the substrate in an acid solution and entering protons into the substrate in exchange for elution of ions in the substrate, and thereby, changing the refractive index of the region. According to the method, the light waveguides 332R, 332G, 332B particularly advantageous in light resistance are obtained. On the other hand, the Ti diffusion method is a method of depositing Ti on the substrate, then, performing heat treatment to diffuse Ti in the substrate, and thereby, changing the refractive index of the region. Each of the light waveguides 332R, 332G, 332B formed according to the method includes a core part having a relatively high refractive index and a cladding part adjacent to the core part and having a relatively low refractive index of the substrate 331. Note that, in this specification, for convenience of explanation, only the core part may be referred to as “light waveguide”. Further, the light waveguides 332R, 332G, 332B may be other members (optical fibers, light waveguides, etc. made of glass or resin) than the substrate 331.

The light waveguide 332R includes a light incident portion 3321R that the red light LR enters, a modulation branch portion 3322R that branches the red light LR from the light incident portion 3321R into two, two linear-shaped modulation linear portions 3323R that propagate the two red lights LR from the modulation branch portion 3322R, a modulation join portion 3324R that joints the red lights LR from the two modulation linear portions 3323R, a coupling portion 3325R that propagates the red light LR joined in the modulation join portion 3324R, and a light exiting portion 3326R that outputs the red light LR from the coupling portion 3325R. Similarly, the light waveguide 332G includes a light incident portion 3321G, a modulation branch portion 3322G, two modulation linear portions 3323G, a modulation join portion 3324G, a coupling portion 3325G, and a light exiting portion 3326G. Further, the light waveguide 332B includes a light incident portion 3321B, a modulation branch portion 3322B, two modulation linear portions 3323B, a modulation join portion 3324B, a coupling portion 3325B, and a light exiting portion 3326B.

The optical axes of the red light LR, green light LG, and blue light LB output from the light exiting portions 3326R, 3326G, 3326B of the light waveguides 332R, 332G, 332B formed as described above may be nonparallel to one another, but preferably parallel to one another. Thereby, scanning with the output red light LR, green light LG, and blue light LB is performed by the light scanning part 35 with the separation distances from one another maintained, and the lights may be imaged on the imaging surface. As a result, the quality of the displayed images may be made higher. Note that, here, “optical axes parallel to one another” refers to a state with angle differences between the optical axes equal to or less than 0.1°.

On the above described substrate 331, the electrodes 333R, 333G, 333B are provided to correspond to the above described light waveguides 332R, 332G, 332B via the buffer layer 334, respectively.

The buffer layer 334 is provided between the substrate 331 and the electrodes 333R, 333G, 333B, and formed using a medium such as e.g. silicon oxide or alumina that absorbs less lights guided in the light waveguides 332R, 332G, 332B.

The electrode 333R includes a signal electrode 3331R placed to overlap with one of the two modulation linear portions 3323R and a ground electrode 3332R placed to overlap with the other of the two modulation linear portions 3323R in the plan view of the substrate 331. Similarly, the electrode 333G includes a signal electrode 3331G and a ground electrode 3332G. Further, the electrode 333B includes a signal electrode 3331B and a ground electrode 3332B. Note that the shapes and the placements of the electrodes 333R, 333G, 333B are appropriately set according to the direction of the crystal axis contained in the substrate 331 or the like, but not limited to those illustrated. For example, the electrode 333R may be provided in a position not overlapping with the light waveguide 332R in the plan view of the substrate 331.

The ground electrodes 3332R, 3332G, 3332B are respectively electrically grounded. On the other hand, potentials based on the electric signals are provided to the signal electrodes 3331R, 3331G, 3331B so that potential differences are generated between the ground electrodes 3332R, 3332G, 3332B and themselves. When the potential differences (voltages) are generated between the signal electrodes 3331R, 3331G, 3331B and the ground electrodes 3332R, 3332G, 3332B, lines of electric force generated between them penetrate the respective core parts of the light waveguides 332R, 332G, 332B. For example, the directions of the lines of electric force are opposite to each other between one and the other of the two modulation linear portions 3323R, and thereby, the directions of the changes of the refractive indexes based on the electrooptical effects produced in the two modulation linear portions 3323R are opposite to each other. Therefore, a phase difference is generated between the red light LR passing through one modulation linear portion 3323R and the red light LR passing through the other modulation linear portion 3323R. The two red lights LR with the phase difference generated as above are joined in the modulation join portion 3324R, and thereby, a light having attenuated intensity (light exiting intensity) compared to the light intensity (light incident intensity) before incidence to the light modulation part 33 may be output to the outside. The same applies to the green light LG and the blue light LB, and the intensity-modulated lights may be output to the outside.

In this regard, the potential differences generated between the signal electrodes 3331R, 3331G, 3331B and the ground electrodes 3332R, 3332G, 3332B are respectively adjusted, and thereby, the above described phase differences may be controlled. Accordingly, the modulation width for the light incident intensity may be controlled (the incident light may be modulated to arbitrary intensity). Therefore, the electrode 333R forms a modulation part 330R (second light modulation part) that can modulate the intensity of the red light LR, the electrode 333G forms a modulation part 330G (first light modulation part) that can modulate the intensity of the green light LG, and the electrode 333B forms a modulation part 330B (third light modulation part) that can modulate the intensity of the blue light LB. Note that the modulation parts 330R, 330G, 330B may be regarded as parts including the corresponding modulation linear portions 3323R, 3323G, 3323B.

More specifically, for example, the voltage applied to the electrode 333R is set so that the difference between the phase of the red light LR passing through one modulation linear portion 3323R and the red light LR passing through the other modulation linear portion 3323R may be shifted by a half wavelength in the modulation join portion 3324R, and thereby, the light exiting intensity may be substantially zero.

Further, the voltage applied to the electrode 333R is set so that the difference between the phase of the red light LR passing through one modulation linear portion 3323R and the red light LR passing through the other modulation linear portion 3323R may be the same in the modulation join portion 3324R, and thereby, the light exiting intensity may be nearly equal to the light incident intensity.

As described above, in the light modulation part 33, the red light LR, green light LG, and blue light LB may be respectively and independently intensity-modulated using the changes of the refractive indexes due to the electrooptical effect of the substrate 331. Particularly, the light modulation part 33 performs modulation outside of the light sources 321R, 321G, 321B, and faster modulation can be performed compared to the case where the red light LR, green light LG, and blue light LB are directly modulated in the light sources 321R, 321G, 321B.

Further, in the image display apparatus 1, it is not necessary to directly modulate the light sources 321R, 321G, 321B, and the light sources 321R, 321G, 321B may be driven to output lights at constant intensity. Therefore, the light sources 321R, 321G, 321B may be driven under a condition of higher light emission efficiency or a condition of higher light emission stability and wavelength stability, and lower power consumption or stabilized operation of the image display apparatus 1 is realized. Further, higher image quality of images drawn on the retina of the eye EY may be realized. In addition, drive circuits necessary for direct modulation of the light sources 321R, 321G, 321B are unnecessary and circuits that continuously drive the light sources 321R, 321G, 321B are relatively simple and have lower cost, and thus, reduction of the cost on the drive circuits 322R, 322G, 322B and downsizing of the light sources 321R, 321G, 321B may be realized.

The wavelength stability of the signal lights may be made higher as described above, and thereby, in the case where a hologram grating is used as the above described reflection part 392 of the optical system 39, the signal light close to the designed wavelength may be entered into the hologram grating. As a result, the deviation from the designed value of the diffraction angle in the hologram grating may be made smaller and image blur may be suppressed.

The light waveguides 332R, 332G, 332B are formed on the single substrate 331. Accordingly, downsizing of the light modulation part 33 may be realized compared to the case where they are formed on substrates different from one another, and then, integrated. As a result, downsizing of the image display apparatus 1 may be realized. Further, the light waveguides 332R, 332G, 332B can be collectively formed (monolithic) and the accuracy of the formation positions of the light waveguides 332R, 332G, 332B may be made higher, and the light exiting directions of the red light LR, green light LG, and blue light LB may be adjusted with higher accuracy. Accordingly, higher image quality of images drawn on the retina of the eye EY may be realized.

The modulation method of the light modulation part 33 is the Mach-Zehnder method, and thereby, the structure of the light modulation part 33 may be made relatively simple and the modulation width of the light modulation part 33 may be arbitrarily and easily adjusted. The modulation width is arbitrarily adjusted, and thereby, for example, higher contrast of the displayed images may be realized. Note that the modulation method of the light modulation part 33 is not limited to the Mach-Zehnder method. An alternative modulation method includes e.g. a directional coupling method.

A light exiting distance W1 as each distance of the distance between the light exiting portion 3326R and the light exiting portion 3326G and the distance between the light exiting portion 3326G and the light exiting portion 3326B is smaller than a light incident distance W2 as each distance of the distance between the light incident portion 3321R and the light incident portion 3321G and the distance between the light incident portion 3321G and the light incident portion 3321B. Thereby, both higher resolution of the image display apparatus 1 and easy placement of the light sources 321R, 321G, 321B (easy design of the optical system) may be realized.

Here, the distance between the coupling portion 3325R and the coupling portion 3325G and the distance between the coupling portion 3325G and the coupling portion 3325B are respectively gradually narrower from the light incident side toward the light exiting side.

Letting the length of the modulation part 330B in the longitudinal direction be L1, the length of the modulation part 330G in the longitudinal direction be L2, and the length of the modulation part 330R in the longitudinal direction be L3 and letting the distance between a reference line DL1 and the light exiting portion 3326B be S1, the distance between a reference line DL2 and the light exiting portion 3326G be S2, and the distance between a reference line DL3 and the light exiting portion 3326R be S3, a relationship L1<L2<L3 is satisfied and a relationship S1>S2>S3 is satisfied. The relationships are satisfied, and thereby, the light modulation part 33 is easily downsized with suppression of increase of crosstalk between the adjacent light waveguides and increase of light loss in bent parts of the light waveguides. Thereby, the small and lightweight light modulation part 33 with less bending loss and sufficiently narrower light exiting distances may be obtained. The light modulation part 33 contributes to realization of the small and lightweight image display apparatus 1 that can display higher resolution images.

Note that “length L1” is the maximum length of the part in the longitudinal direction (y-axis direction) that contributes to modulation in the modulation part 330B, and specifically, a length from the branch point of the modulation branch portion 3322B to the join point of the modulation join portion 3324B along the y-axis direction. Further, the lengths L2, L3 are defined similarly to the length L1. “Reference line DL1” is an imaginary line parallel to the longitudinal direction of the modulation part 330B and passing through a connecting portion between the modulation part 330B and the coupling portion 3325B (the joint point of the modulation join portion 3324B). Further, the reference lines DL2, DL3 are defined similarly to the reference line DL1. “Distance S1” is a distance (minimum distance) between the reference line DL1 and the light exiting portion 3326B. Further, the distances S2, S3 are defined similarly to the distance S1.

The eye EY of the user is irradiated with the signal light LL1 as the bundle of lights of the red light LR, green light LG, and blue light LB intensity-modulated in the above described light modulation part 33 via the lens 34, the light scanning part 35, and the optical system 39. Here, when the red light LR, green light LG, and blue light LB pass through the lens 34, as shown in FIG. 9, the blue light LB, green light LG, and red light LR are arranged in this order in the x-axis directions and the green light LG passes through a center axis a of the lens 34. Therefore, a center axis aG of the green light LG passes closer to the center side of the lens 34 than a center axis aR of the red light LR and a center axis aB of the blue light LB. In the embodiment, as shown in FIGS. 9 and 10, the center axis aG of the green light LG is aligned (or crossed) with the center axis a (optical axis) within the lens 34. Further, the center axis aR of the red light LR deviates toward one side with respect to the center axis a within the lens 34 and the center axis aB of the blue light LB deviates toward the other side with respect to the center axis a within the lens 34. As described above, the green light LG with higher resolution for the human eye passes closer to the center side (a position closer to the center) of the lens 34 than the red light LR and the blue light LB having lower resolution, and thereby, the green color of the displayed image may be faithfully reproduced and, as a result, an advantage that high quality displayed images may be realized is obtained.

The advantage is specifically described. In the optical system including the lens 34 and the optical system 39, as shown in FIG. 11, on the retina RE as the imaging surface, the green light LG tends to converge on a single point of an imaging point fG, however, the red light LR and the blue light LB having higher image heights than the green light LG are harder to converge on single points because imaging points fB, fR shift due to aberration. Therefore, the spot shape of the green light LG on the retina RE is extremely small and closer to a circle, however, the respective spot shapes of the red light LR and the blue light LB on the retina RE are larger and more distorted than the spot shape of the green light LG.

Here, optical sensitivity of the human eye differs depending on the wavelength. Of the red, green, and blue colors, the sensitivity to green (relative visibility) is the highest. Therefore, formation of green pixels with higher quality has the highest efficiency for improvement of image quality. On the other hand, the red and blue colors have lower relative visibility than the green color, and, if the quality of red and blue pixels is deteriorated to a certain degree, the influence on the image quality is smaller than the quality of green pixels.

On this account, the spot shape of the green light LG on the retina RE is preferentially formed in a smaller shape closer to a circle than the spot shapes of the red light LR and the blue light LB and green pixels with higher quality are formed, and thereby, images with higher quality may be formed.

On the other hand, if the center axis aG of the green light LG passes closer to the outer circumference side of the lens 34 than the center axis aR of the red light LR and the center axis aB of the blue light LB when the red light LR, green light LG, and blue light LB pass through the lens 34, the spot shape of the red light LR or the blue light LB on the retina RE is smaller and closer to a circle, however, the spot shape of the green light LG on the retina RE is larger and more distorted than the spot shape of the red light LR or the blue light LB. Accordingly, the quality of the green pixels having the lower relative visibility is deteriorated and the deterioration largely affects the image quality deterioration, and realization of high-quality displayed images is impossible.

According to the above described image display apparatus 1, it is not necessary to directly modulate the light sources 321R, 321G, 321B, but the lights from the light sources 321R, 321G, 321B may be modulated by the light modulation part 33 outside of the light sources 321R, 321G, 321B. Accordingly, the frequency shift of the red light LR, green light LG, and blue light LB due to direct modulation of the light sources 321R, 321G, 321B may be reduced and, as a result, color tone shifts of displayed images may be reduced and high-quality displayed images may be obtained. Further, the center axis aG of the green light LG passes closer to the center side of the lens 34 than the center axis aR of the red light LR and the center axis aB of the blue light LB, and thereby, the quality of the pixels of the green light LG having the higher relative visibility may be preferentially made higher than the quality of the pixels of the red light LR and the blue light LB having the lower relative visibility. As a result, also, in this regard, the high-quality displayed images may be realized. Therefore, the head mount display that can display high-quality images in full color may be realized.

### Second Embodiment

Next, the second embodiment will be explained.

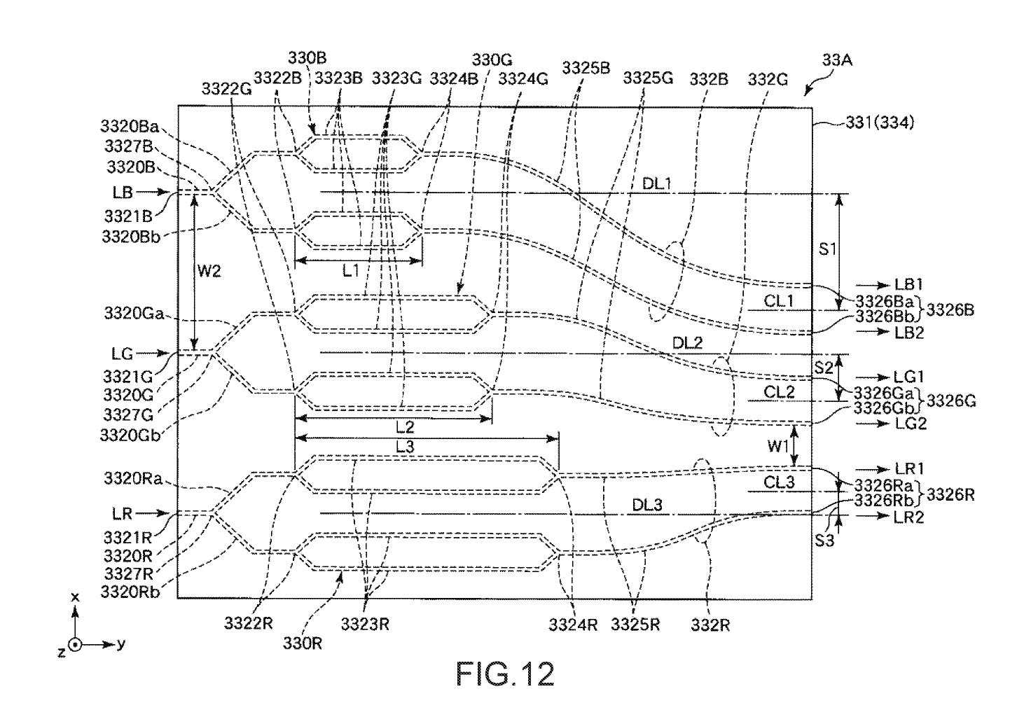

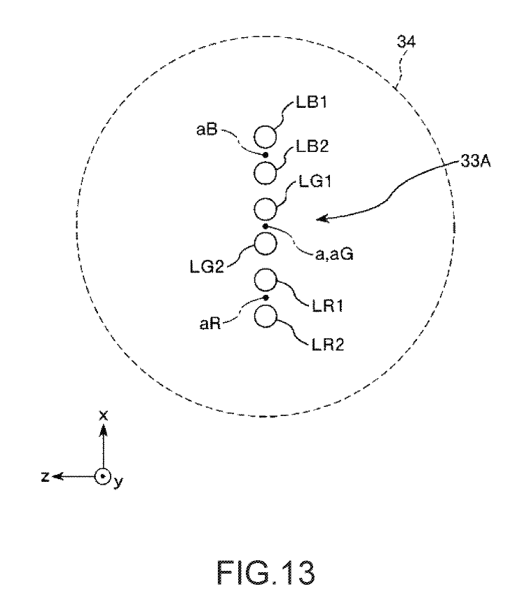

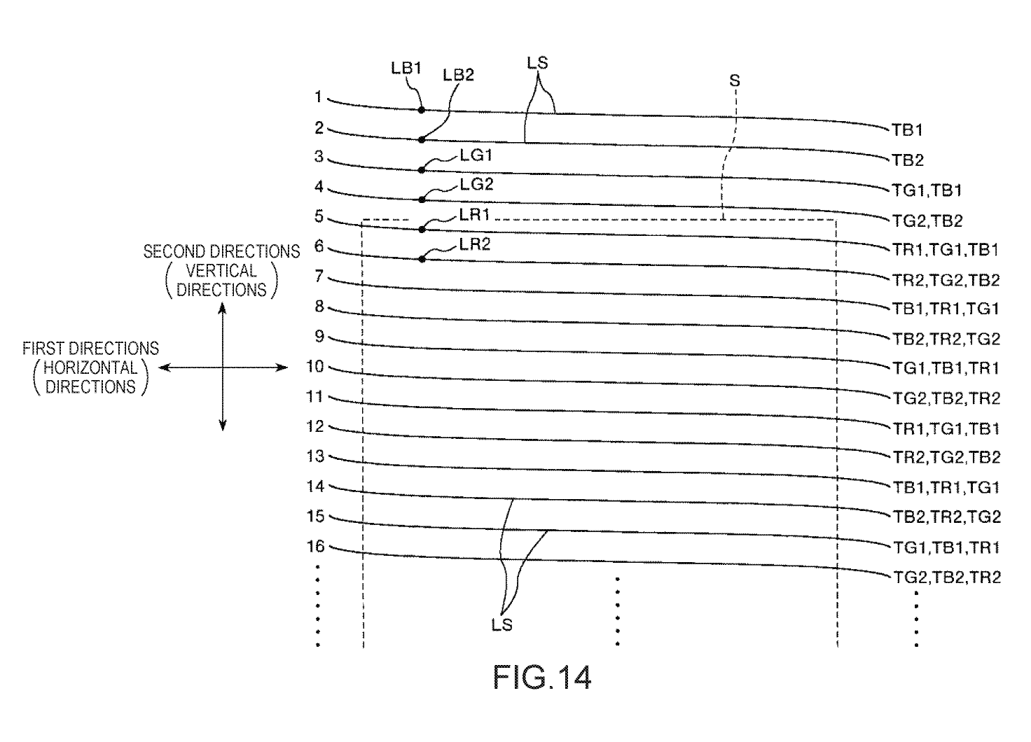

FIG. 12 is a plan view of a light modulation part of an image display apparatus according to the second embodiment of the invention. FIG. 13 shows positional relationships between a condenser lens and signal lights (as seen from a direction parallel to an optical axis) shown in FIG. 12. FIG. 14 schematically shows scanning trajectories of the signal lights on a projection surface in the image display apparatus shown in FIG. 12.

The embodiment is the same as the above described first embodiment except that the configuration of the light modulation part is different.

As below, the second embodiment will be explained with a focus on the differences from the above described first embodiment and the explanation of the same items will be omitted.

The image display apparatus of the embodiment is the same as the image display apparatus 1 of the first embodiment except that a light modulation part 33A shown in FIG. 12 is provided in place of the light modulation part 33 of the above described first embodiment.

In the light modulation part 33A, as shown in FIG. 12, a light waveguide 332R that propagates red light LR has a distribution branch portion 3327R that branches the red light LR from a light incident portion 3321R into two, two red lights LR from the distribution branch portion 3327R are respectively further branched into two by modulation branch portions 3322R. Further, like the modulation branch portion 3322R of the above described first embodiment, two modulation linear portions 3323R, a modulation join portion 3324R, a coupling portion 3325R, and a light exiting portion 3326R are connected to the modulation branch portion 3322R in this order.

That is, the light waveguide 332R according to the embodiment has a main line 3320R extending from the light incident portion 3321R and two branch lines 3320Ra and 3320Rb branched from the main line 3320R in the distribution branch portion 3327R. Each of the branch lines 3320Ra and 3320Rb includes the modulation branch portions 3322R, the two modulation linear portions 3323R, the modulation join portion 3324R, the coupling portion 3325R, and the light exiting portion 3326R (light exiting portion 3326Ra or light exiting portion 3326Rb).

In the light waveguide 332R, the red light LR entered into the light waveguide 332R is distributed into two in the distribution branch portion 3327R, and finally output as two luminous fluxes (red lights LR1, LR2). In this regard, the red lights LR may be modulated independently from each other in each of the branch line 3320Ra and the branch line 3320Rb. Note that, in FIG. 12, for convenience of explanation, only the position of the modulation part 330R is shown and the electrode 333R is not shown.

Similarly, a light waveguide 332G according to the embodiment has a main line 3320G extending from a light incident portion 3321G and two branch lines 3320Ga and 3320Gb branched from the main line 3320G in a distribution branch portion 3327G. Each of the branch lines 3320Ga and 3320Gb includes a modulation branch portion 3322G, two modulation linear portions 3323G, a modulation join portion 3324G, a coupling portion 3325G, and a light exiting portion 3326G (light exiting portion 3326Ga or light exiting portion 3326Gb). Further, a light waveguide 332B according to the embodiment has a main line 3320B extending from a light incident portion 3321B and two branch lines 3320Ba and 3320Bb branched from the main line 3320B in a distribution branch portion 3327B. Each of the branch lines 3320Ba and 3320Bb includes a modulation branch portion 3322B, two modulation linear portions 3323B, a modulation join portion 3324B, a coupling portion 3325B, and a light exiting portion 3326B (light exiting portion 3326Ba or light exiting portion 3326Bb).

The luminous fluxes including the two red lights (light beams) LR1, LR2 (second light), two green lights (light beams) LG1, LG2 (first light), two blue lights (light beams) LB1, LB2 (third light) intensity-modulated by the above described light modulation part 33A enter the lens 34. Here, when the luminous fluxes pass through the lens 34, as shown in FIG. 13, the blue light LB1, the blue light LB2, the green light LG1, the green light LG2, the red light LR1, and the red light LR2 are arranged in this order in the x-axis direction, and the luminous flux (first light) including the green light LG1 and the green light LG2 passes the center axis a of the lens 34. Therefore, a center axis aG of the luminous flux (first light) including the green light LG1 and the green light LG2 passes closer to the center side of the lens 34 than a center axis aR of the luminous flux (second light) including the red light LR1 and the red light LR2 and a center axis aB of the luminous flux (third light) including the blue light LB1 and the blue light LB2. Note that “center axis aG” refers to a line segment located in the middle between the center axes of the lights located at the outermost sides of the plurality of lights (light beams) forming the first light (luminous flux) and, in the embodiment, a line segment located in the middle between the center axis of the green light LG1 and the center axis of the green light LG2. Further, the center axes aR, aB are defined similarly to the center axis aG.

In the embodiment, the center axis aG of the green lights LG1, LG2 is aligned (or crossed) with the center axis a (optical axis) within the lens 34. Therefore, the center axis a within the lens 34 is located between the green light LG1 and the green light LG2. As described above, also, in the case where the two red lights LR1, LR2, the two green lights LG1, LG2, and the two blue lights LB1, LB2 are used, the green lights LG1, LG2 with higher resolution for the human eye pass closer to the center side of the lens 34 than the red lights LR1, LR2 and the blue lights LB1, LB2 having lower resolution, and thereby, the green color of the displayed images may be faithfully reproduced and, as a result, an advantage that high quality displayed images may be realized is obtained.

The bundle of lights including the two red lights LR1, LR2, the two green lights LG1, LG2, and the two blue lights LB1, LB2 passing through the lens 34 are used for scanning in the light scanning part 35.

An irradiated point of the blue light LB1, an irradiated point of the blue light LB2, an irradiated point of the green light LG1, an irradiated point of the green light LG2, an irradiated point of the red light LR1, and an irradiated point of the red light LR2 on an image surface (projection surface) at a certain time are arranged side by side in the second directions as shown by six points in FIG. 14, and used for scanning in the first directions and the second directions with the positional relationship maintained. Thereby, scanning trajectories TB1 of the blue light LB1, scanning trajectories TB2 of the blue light LB2, scanning trajectories TG1 of the green light LG1, scanning trajectories TG2 of the green light LG2, scanning trajectories TR1 of the red light LR1, and scanning trajectories TR2 of the red light LR2 are respectively formed.

The scanning trajectory TB1 is formed on a scanning line LS1, the scanning trajectory TB2 is formed on a scanning line LS2, the scanning trajectory TG1 is formed on a scanning line LS3, the scanning trajectory TG2 is formed on a scanning line LS4, the scanning trajectory TR1 is formed on a scanning line LS5, and the scanning trajectory TR2 is formed on a scanning line LS6. This is the first scanning.

Then, the respective irradiated points of the red light LR1, the red light LR2, the green light LG1, the green light LG2, the blue light LB1, and the blue light LB2 are shifted in the second direction (downward in FIG. 14), and then, the second scanning is performed. In this regard, the points are shifted by two scanning lines LS, and thereby, the scanning trajectory TG1 is formed on the scanning trajectory TR1 in the first scanning and the scanning trajectory TG2 is formed on the scanning trajectory TR2 in the first scanning. Thereby, on the scanning line LS5, the scanning trajectory TR1 and the scanning trajectory TG1 are superimposed and produce a color formed by a combination of the red light LR1 and the green light LG1. Further, on the scanning line LS6, the scanning trajectory TR2 and the scanning trajectory TG2 are superimposed and produce a color formed by a combination of the red light LR2 and the green light LG2.

Then, the respective irradiated points of the red light LR1, the red light LR2, the green light LG1, the green light LG2, the blue light LB1, and the blue light LB2 are further shifted in the second direction (downward in FIG. 14), and then, the third scanning is performed. In this regard, the points are shifted by two scanning lines LS, and thereby, on the scanning line LS5, the scanning trajectory TB1 in the third scanning is additionally superimposed on the scanning trajectory TR1 in the first scanning and the scanning trajectory TG1 in the second scanning. Thereby, a color formed by a combination of the red light LR1, the green light LG1, and the blue light LB1 is produced. Further, on the scanning line LS6, the scanning trajectory TB2 in the third scanning is additionally superimposed on the scanning trajectory TR2 in the first scanning and the scanning trajectory TG2 in the second scanning. Thereby, a color formed by a combination of the red light LR2, the green light LG2, and the blue light LB2 is produced.

Note that, in FIG. 14, the signs of the scanning trajectories are shown on right sides of the scanning lines LS. Further, the scanning trajectories are superimposed on the same scanning line LS, the signs of the plurality of scanning trajectories are shown side by side.

The above described scanning is further repeated at four times, five times, . . . , and thereby, on the scanning line LS5 and the subsequent lines LS, lights of three colors may be superimposed. Thus, the lights of the respective colors are blinked on and off independently of one another, and thereby, arbitrary colors and brightness by combinations of three primary colors of lights may be represented. Therefore, in the embodiment, an image display area S in which the user visually recognizes an image may be set to contain the scanning line LS5 and the subsequent scanning lines LS. In other words, it is preferable to exclude the area containing the scanning lines LS1 to LS4 because drawing in arbitrary colors and brightness is impossible therein, and, in this case, it is preferable to form the scanning lines LS1 to LS4 in positions in which visual recognition by the user is impossible.

As described above, drawing is performed using the luminous flux of the two sets of red lights, green lights, and blue lights, and thereby, the scanning lines LS may be increased without raising the drive frequency of the light scanning part 35 compared to the case where the luminous flux includes single sets of red lights, green lights, and blue lights. Therefore, even in the case where the drive frequency is hard to be raised because of the structure of the light scanning part 35, high-resolution images may be displayed regardless of the structure of the light scanning part 35.

According to the light modulation part 33A of the embodiment, the light exiting distance W1 may be made sufficiently smaller. Therefore, even in the case where there is an area excluded from the image display area S, its area (width) may be made sufficiently smaller.

Note that, in the image display apparatus according to the embodiment, the light exiting distance W1 is made smaller, and thereby, e.g. the irradiated points of the red light LR1 and the irradiated points of the red light LR2 may be located on the scanning lines LS adjacent to each other, however, this arrangement is not necessarily required. The irradiated points of the red light LR1 and the irradiated points of the red light LR2 may be located on the scanning lines LS not adjacent to each other.

Further, also, in the light modulation part 33A shown in FIG. 13, a relationship L1<L2<L3 is satisfied and a relationship S1>S2>S3 is satisfied. In the embodiment, “reference line DL1” is an imaginary line parallel to the longitudinal direction of the modulation part 330B and passing through a center point of the length of the modulation part 330B along the x-axis directions. The center point of the length of the modulation part 330B along the x-axis directions corresponds to a midpoint of the line segment connecting the two modulation join portions 3024B. The center point may be regarded as a connecting portion between the modulation part 330B and the coupling portion 3325B. Further, the reference lines DL2, DL3 are defined similarly to the reference line DL1. “Distance S1” is the minimum distance between the midpoint of the line segment connecting the light exiting portion 3326Ba and the light exiting portion 3326Bb and the reference line DL1. In other words, letting a line passing through the midpoint of the line segment connecting the light exiting portion 3326Ba and the light exiting portion 3326Bb in parallel to the reference line DL1 be a reference line CL1, the distance S1 corresponds to the distance between the reference line DL1 and the reference line CL1. Further, the distances S2, S3 are defined using reference lines CL2, CL3 similarly to the distance S1.

According to the above described image display apparatus of the embodiment, images are displayed using the two red lights LR1, LR2 (second light), the two green lights LG1, LG2 (first light), and the two blue lights LB1, LB2 (third light), and thereby, higher resolution of the displayed images may be realized.

Further, the light modulation part 33A branches and outputs the red light LR, green light LG, and blue light LB into the two red lights LR1, LR2, the two green lights LG1, LG2, and the two blue lights LB1, LB2, and thereby, the two red lights LR1, LR2, the two green lights LG1, LG2, and the two blue lights LB1, LB2 may be generated without increase in the number of light sources while the apparatus is downsized.

### Third Embodiment

Next, the third embodiment will be explained.

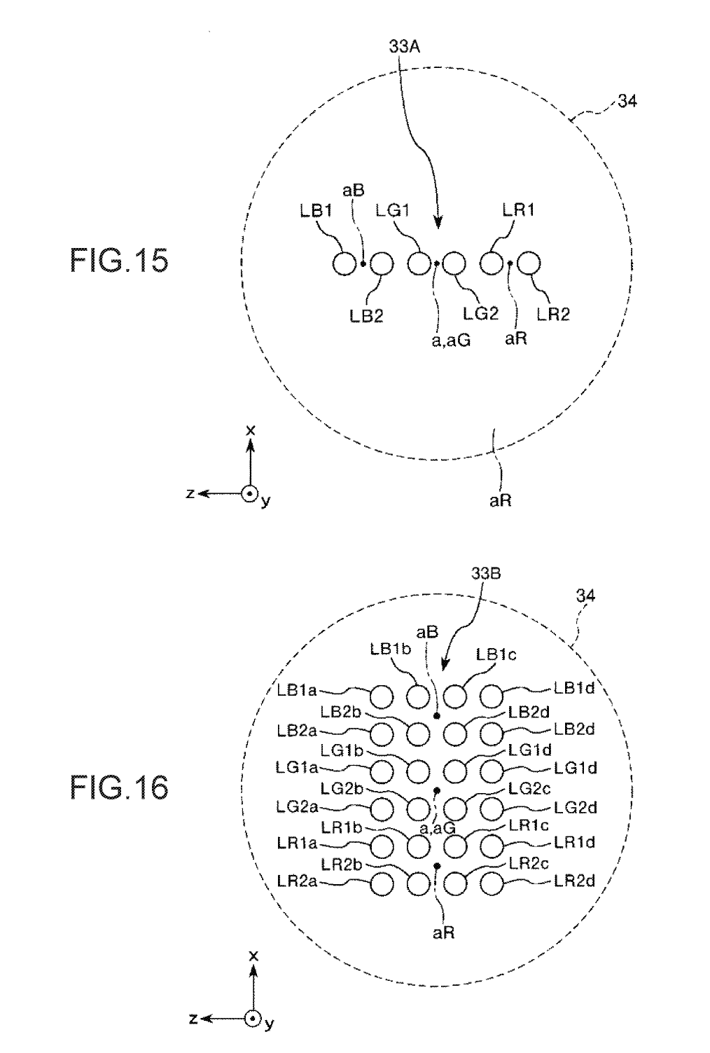

FIG. 15 shows positional relationships between a condenser lens and signal lights (as seen from a direction parallel to an optical axis) in an image display apparatus according to the third embodiment of the invention.

The embodiment is the same as the above described first embodiment except that the configuration of the light modulation part is different. Further, the embodiment is the same as the above described second embodiment except that the installation attitude of the light modulation part and a configuration relating thereto are different.

As below, the third embodiment will be explained with a focus on the differences from the above described embodiments and the explanation of the same items will be omitted.

The image display apparatus of the embodiment has a configuration in which the installation attitude of the light modulation part 33A of the above described second embodiment is rotated by 90° about the center axis a of the lens 34 with respect to the light scanning part 35 (not shown). Thereby, when a luminous flux including the two red lights (light beams) LR1, LR2, two green lights (light beams) LG1, LG2, two blue lights (light beams) LB1, LB2 passes through the lens 34, as shown in FIG. 15, the blue light LB1, the blue light LB2, the green light LG1, the green light LG2, the red light LR1, and the red light LR2 are arranged in this order in the z-axis direction, and the luminous flux including the green light LG1 and the green light LG2 passes the center axis a of the lens 34. Therefore, a center axis aG of the green lights LG1, LG2 (a center axis of a luminous flux including the green light LG1 and the green light LG2) passes closer to the center side of the lens 34 than a center axis aR of the red lights LR1, LR2 (a center axis of a luminous flux including the red light LR1 and the red light LR2) and a center axis aB of the blue lights LB1, LB2 (a center axis of a luminous flux including the blue light LB1 and the blue light LB2).

Even in the case where the red lights LR1, LR2, the green lights LG1, LG2, and the blue lights LB1, LB2 pass through the lens 34 in the arrangement, as is the case of the above described second embodiment, the green color of the displayed images may be faithfully reproduced and, as a result, an advantage that high quality displayed images may be realized is obtained.

### Fourth Embodiment

Next, the fourth embodiment will be explained.

FIG. 16 shows positional relationships between a condenser lens and signal lights (as seen from a direction parallel to an optical axis) in an image display apparatus according to the fourth embodiment of the invention.

The embodiment is the same as the above described first embodiment except that the configuration of the light modulation part is different. Further, the embodiment is the same as the above described second embodiment except that the number of light modulation parts and a configuration relating thereto are different.

As below, the fourth embodiment will be explained with a focus on the differences from the above described embodiments and the explanation of the same items will be omitted.

The image display apparatus of the embodiment includes a light modulation part 33B having a configuration in which four light modulation parts 33A of the above described second embodiment are stacked in the z-axis direction (not shown). Thereby, a luminous flux including eight red lights (light beams) LR1a, LR1b, LR1c, LR1d, LR2a, LR2b, LR2c, LR2d, eight green lights (light beams) LG1a, LG1b, LG1c, LG1d, LG2a, LG2b, LG2c, LG2d, and eight blue lights (light beams) LB1a, LB1b, LB1c, LB1d, LB2a, LB2b, LB2c, LB2d passes through the lens 34 as a signal light LL1.

In this regard, as shown in FIG. 16, the blue light LB1a, the blue light LB2a, the green light LG1a, the green light LG2a, the red light LR1a, and the red light LR2a are arranged in this order in the x-axis direction. Similarly, the blue lights LB1b, LB1c, LB1d, the blue lights LB2b, LB2c, LB2d, the green lights LG1b, LG1c, LG1d, the green lights LG2b, LG2c, LG2d, the red lights LR1b, LR1c, LR1d, and the red lights LR2b, LR2c, LR2d are arranged in the x-axis directions, respectively. Further, the four blue lights LB1a, LB1b, LB1c, LB1d are arranged in this order in the z-axis direction. Similarly, the four blue lights LB2a, LB2b, LB2c, LB2d, LG2c, LG2d, the four red lights LR1a, LR1b, LR1c, LR1d, the four red lights LR2a, LR2b, LR2c, LR2d, the four green lights LG1a, LG1b, LG1c, LG1d, and the four green lights LG2a, LG2b, LG2c, LG2d are respectively arranged in the z-axis directions.

Here, a center axis aG of a luminous flux including the eight green lights LG1a, LG1b, LG1c, LG1d, LG2a, LG2b, LG2c, LG2d passes closer to the center side of the lens 34 than a center axis aR of a luminous flux including the eight red lights LR1a, LR1b, LR1c, LR1d, LR2a, LR2b, LR2c, LR2d and a center axis aB of a luminous flux including the eight blue lights LB1a, LB1b, LB1c, LB1d, LB2a, LB2b, LB2c, LB2d. According to the arrangement, the green color of the displayed images may be faithfully reproduced and, as a result, an advantage that high quality displayed images may be realized is obtained. Further, higher resolution of the displayed images may be realized compared to the second embodiment.

### Fifth Embodiment

Next, the fifth embodiment will be explained.

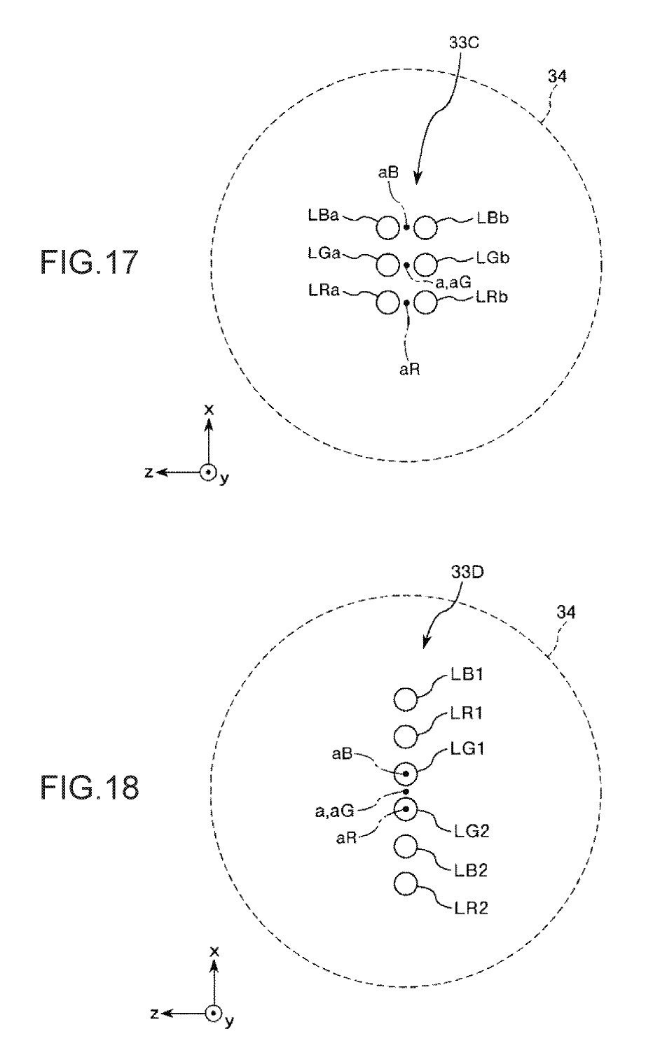

FIG. 17 shows positional relationships between a condenser lens and signal lights (as seen from a direction parallel to an optical axis) in an image display apparatus according to the fifth embodiment of the invention.

The embodiment is the same as the above described first embodiment except that the configuration of the light modulation part is different.

As below, the fifth embodiment will be explained with a focus on the differences from the above described embodiments and the explanation of the same items will be omitted.

The image display apparatus of the embodiment includes a light modulation part 33C having a configuration in which two light modulation parts 33 of the above described first embodiment are stacked in the z-axis direction (not shown). Thereby, a luminous flux including two red lights LRa, LRb, two green lights LGa, LGb, and two blue lights LBa, LBb passes through the lens 34 as a signal light LL1.

In this regard, as shown in FIG. 17, the blue light LBa, the green light LGa, and the red light LRa are arranged in this order in the x-axis direction. Similarly, the blue light LBb, the green light LGb, and the red light LRb are arranged in the x-axis direction. Further, the two blue lights LBa, LBb are arranged in the z-axis directions. Similarly, the two green lights LGa, LGb and the two red lights LRa, LRb are respectively arranged in the z-axis directions.

Here, a center axis aG of a luminous flux including the green lights (light beams) LGa, LGb passes closer to the center side of the lens 34 than a center axis aR of a luminous flux including the red lights (light beams) LRa, LRb and a center axis aB of a luminous flux including the blue lights LBa, LBb. According to the arrangement, the green color of the displayed images may be faithfully reproduced and, as a result, an advantage that high quality displayed images may be realized is obtained.

### Sixth Embodiment

Next, the sixth embodiment will be explained.

FIG. 18 shows positional relationships between a condenser lens and signal lights (as seen from a direction parallel to an optical axis) in an image display apparatus according to the sixth embodiment of the invention.

The embodiment is the same as the above described first embodiment except that the configuration of the light modulation part is different.

As below, the sixth embodiment will be explained with a focus on the differences from the above described embodiments and the explanation of the same items will be omitted.

The image display apparatus of the embodiment includes a light modulation part 33D in place of the light modulation part 33 of the above described first embodiment. The light modulation part 33D outputs a luminous flux including two red lights LR1, LR2, two green lights LG1, LG2, and two blue lights LB1, LB2 passes through the lens 34 as a signal light LL1. When the luminous flux passes through the lens 34, as shown in FIG. 18, the blue light LB1, the red light LR1, the green light LG1, the green light LG2, the blue light LB2, and the red light LR2 are arranged in this order in the x-axis direction, and a luminous flux including the green light LG1 and the green light LG2 passes through the center axis a of the lens 34. Therefore, a center axis aG of the green lights LG1, LG2 (a center axis of the luminous flux including the green light LG1 and the green light LG2) passes closer to the center side of the lens 34 than a center axis aR of the red lights LR1, LR2 (a center axis of a luminous flux including the red light LR1 and the red light LR2) and a center axis aB of the blue lights LB1, LB2 (a center axis of a luminous flux including the blue light LB1 and the blue light LB2).

Even in the case where the red lights LR1, LR2, the green lights LG1, LG2, and the blue lights LB1, LB2 pass through the lens 34 in the arrangement, as is the case of the above described second embodiment, the green color of the displayed images may be faithfully reproduced and, as a result, an advantage that high quality displayed images may be realized is obtained.

### Seventh Embodiment

Next, the seventh embodiment will be explained.

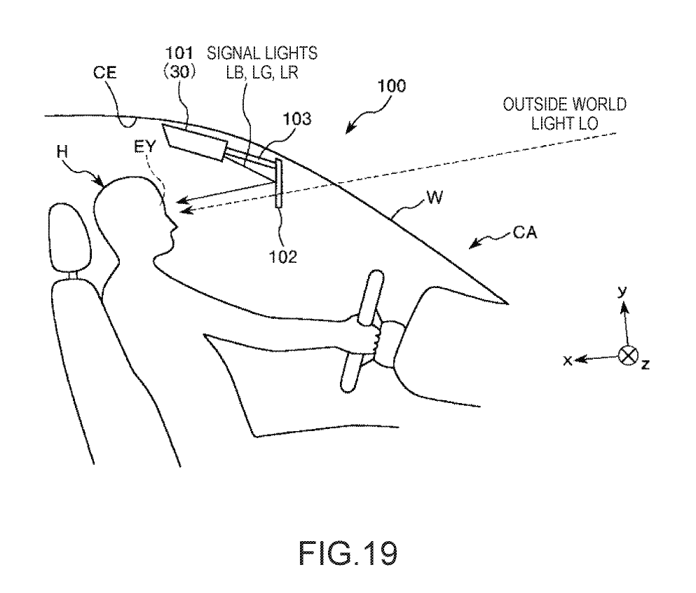

FIG. 19 shows a schematic configuration of an image display apparatus (head-up display) according to the seventh embodiment of the invention.

The embodiment is the same as the above described first embodiment except that the invention is applied to a head-up display.

As below, the seventh embodiment will be explained with a focus on the differences from the above described embodiments and the explanation of the same items will be omitted.

An image display apparatus 100 according to the embodiment is the so-called head-up display, and is attached to a ceiling part CE of an automobile CA for use and allows a user (a user of the automobile CA) to visually recognize an image as a virtual image superimposed on an outside world image via a front window W of the automobile CA. As shown in FIG. 19, the image display apparatus 100 includes a light source unit 101 containing a picture light generation part 30, a reflection part 102, and a frame 103 that connects the light source unit 101 and the reflection part 102.

The light source unit 101 may be fixed to the ceiling part CE in any method. For example, the unit is attached to a sun visor using a band, clip, or the like for fixation. The light source unit 101 contains the picture light generation part 30 of the above described first embodiment and outputs a signal light LL1 used for two-dimensionally scanning (i.e., picture light LL2) from the picture light generation part 30 toward the reflection part 102.

The frame 103 includes e.g. a pair of elongated members that connect the light source unit 101 and the reflection part 102 and fixes the reflection part 102 with respect to the light source unit 101.

The reflection part 102 is a half mirror and has a function of reflecting the signal light LL1 (picture light LL2) from the light source unit 101 toward an eye EY of the user in use and transmitting an outside world light LO from outside of the automobile CA through the front window W toward the eye EY of the user in use. Thereby, the user may visually recognize a virtual image (image) formed by the signal light LL1 (picture light LL2) while visually recognizing an outside world image. That is, the see-through head-up display may be realized.

The image display apparatus 100 includes the picture light generation part 30 of the first embodiment as described above, and the same function and effect as those of the first embodiment may be obtained. Thereby, the head-up display that can display high-quality images may be realized.

Note that, in the embodiment, the case where the light source unit 101, the reflection part 102, and the frame 103 are attached to the ceiling part CE of the automobile CA is explained as an example, however, they may be attached onto a dashboard of the automobile CA or their partial configurations may be fixed to the front window W. Further, the image display apparatus 100 may be attached not only to the automobile but also to various moving objects including an airplane, a ship, a constructing machine, a heavy machine, a motorcycle, a bicycle, and a spaceship.

As above, the image display apparatus according to the invention is explained based on the illustrated embodiments, however, the invention is not limited to those. For example, in the invention, the configurations of the respective parts described in the embodiments may be replaced by arbitrary configurations having the same functions and other arbitrary configurations may be added thereto. Further, the configurations of the respective embodiments may be combined as appropriate.

In the above described embodiments, the case where the light modulation part modulates the intensity of the light from the light source is explained as an example, however, the invention is not limited to that. For example, the light modulation part may modulate a wavelength, phase, or the like of the light from the light source. In this case, at least one of the intensity, wavelength, phase, or the like of the light output from the light source may be directly modulated.

Further, in the above described first to sixth embodiments, the case where the invention is applied to the spectacle-shaped head mount display is explained as an example, however, the invention is not limited to that. For example, the invention can be applied to a helmet-shaped or headset-shaped head mount display and a head mount display having a form supported by the body e.g. the neck, shoulder, or the like of the user.

Furthermore, in the above described first to sixth embodiments, the case where the whole head mount display is attached to the head of the user is explained as an example, however, the head mount display may be divided in a part attached to the head of the user and the part attached to or carried on another part than the head of the user.

The configuration of the optical scanner explained in the above described embodiments is an example, however, the invention is not limited to that. For example, the shapes etc. of the respective parts may be changed as appropriate. Further, in the above described embodiments, the case where the picture light is generated by two-dimensional scanning of signal lights by the single optical scanner is explained as an example, however, the picture light may be generated by two-dimensional scanning of signal lights using two optical scanners.

The entire disclosure of Japanese Patent Application No. 2016-004160, filed Jan. 13, 2016 is expressly incorporated by reference herein.

What is claimed is:

1. An image display apparatus comprising:
a light source part including a first light source that outputs a green first light and a second light source that outputs a second light in a different color from the color of the first light;
a light modulation part, in which the first light and the second light are entered, that can respectively independently modulate the first light and the second light;
a condenser lens that condenses the first light and the second light modulated by the light modulation part; and
a light scanning part that performs scanning with the first light and the second light condensed by the condenser lens,
wherein a center axis of the first light passes closer to a center side of the condenser lens than a center axis of the second light.

2. The image display apparatus according to claim 1, wherein the light modulation part includes:
a substrate formed using a material having an electrooptical effect;
a first light waveguide provided on the substrate, into which the first light is entered;
a second light waveguide provided on the substrate, into which the second light is entered;
a first modulation part that modulates the first light entering the first light waveguide; and
a second modulation part that modulates the second light entering the second light waveguide.

3. The image display apparatus according to claim 2, wherein respective modulation methods of the first modulation part and the second modulation part are Mach-Zehnder methods.

4. The image display apparatus according to claim 1, wherein the first light is a luminous flux containing a plurality of light beams of green, and
the second light is a luminous flux containing a plurality of light beams of a different color from that of the first color.

5. The image display apparatus according to claim 4, wherein the light modulation part branches and outputs the first light into a plurality of first lights and branches and outputs the second light into a plurality of second lights.

6. The image display apparatus according to claim 1, wherein the light source part includes a third light source that outputs a third light in a different color from the colors of the first light and the second light, and
the light modulation part, in which the third light is entered, that can modulate the third light independently of the first light and the second light.

7. The image display apparatus according to claim 6, wherein the center axis of the first light passes closer to the center side of the condenser lens than a center axis of the third light.

8. The image display apparatus according to claim 1, being a head mount display.

9. The image display apparatus according to claim 1, being a head-up display.
